(19) United States
(12) Patent Application Publication
(10) Pub. No.: US 2016/0132780 A1
(43) Pub. Date: May 12, 2016

(54) Automatic Selection of Images for an Application

(71) Applicant: Google Inc., Mountain View, CA (US)

(72) Inventors: Hrishikesh Aradhye, Santa Clara, CA (US); Atul Kumar, Palo Alto, CA (US)

(21) Appl. No.: 14/539,777

(22) Filed: Nov. 12, 2014

(51) Int. Cl. G06N 5/04; H04L 29/08

(52) U.S. Cl. CPC G06N 5/048; H04L 67/10

(57) ABSTRACT

Images and/or videos may be recommended to a developer based on a classifier. The classifier may determine an application metric that may measure the likelihood that an application is successful for applications on an application store. The system may extract and/or determine features from images and/or videos associated with a training set of applications that are deemed successful. A classifier may be trained on the training set of applications to determine which features of the images and/or videos are associated with the application metric. The classifier may be applied to new and/or existing applications on the application store to generate a recommendation of which images the developer of the application should use to increase the likelihood that the application will be successful.

### BACKGROUND

Application stores provide a way for application developers to disseminate their applications to a user base. An application store may provide an indication of a user rating, a number of downloads, user comments, images, videos, description, related applications, etc. In some instances, the application store may generate a recommendation for one or more applications based on a user's purchase history, the user's browsing history, the purchases of the user's friends, downloads, ratings of applications, etc. A developer may upload some of the content provided by the application store such as images and/or videos as one way to market an application to end users. Screenshots, for example, may be visible to end users when they view an application's page on the application store. Generally, the content provided by a developer to market the application might influence whether or not a user elects to install and/or purchase an application. End users, however, may not spend much time contemplating an application, such as viewing screenshots. Thus, it is important to select images that will be informative and/or interesting to a particular user. At present, developers may select images the developer feels are interesting without consideration for an end user's preferences or what constitutes a desirable image from a marketing perspective.

### BRIEF SUMMARY

According to an implementation, an application store server may determine an application metric for each of a plurality of applications hosted by the application store. The application metric may refer to a composite score based on one or more of: a conversion statistic, a download statistic, a rating, a retention statistic, and a popularity statistic. A first of the applications may be selected based on the application metric. Features for images associated with the first application may be obtained. A classifier may be obtained by determining a feature set. The feature set may represent a portion of the features associated with the images of the first application.

In an implementation, a system is disclosed that includes a database and a processor, both of which may be associated with an application store. The database may be configured to store an application metric. The application metric may refer to a composite score that is based on at least one of: a conversion statistic, a download statistic, a rating, a retention statistic, and a popularity statistic. The processor may be communicatively coupled to the database and configured to determine an application metric for each of a plurality of applications hosted by the application store. The processor may select a first application based on the application metric. Features for images associated with the first application on the application store may be obtained. The processor may obtain a classifier by determining a feature set that includes a portion of the features that are correlated with the application metric.

In an implementation, a system according to the presently disclosed subject matter includes an application store server that includes a database and a processor. The system may include a means for determining an application metric for applications hosted by the application store. The application metric may refer to a composite score based on at least one of: a conversion statistic, a download statistic, a rating, a retention statistic, and a popularity statistic. The system may include a means for selecting a first application based on the application metric. The system may include a means for obtaining features for images associated with the first application. The system may obtain a classifier by determining a feature set. The feature set may refer to a portion of the features that are correlated with the application metric.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process for training a classifier that can determine which one or more images (or video) to select to increase the likelihood that the application will be downloaded by end users as disclosed herein.

FIG. 2 is an example system that can obtain a classifier for images uploaded to an application store as disclosed herein.

FIG. 3 shows a computer according to an implementation of the disclosed subject matter.

FIG. 4 shows a network configuration according to an implementation of the disclosed subject matter.

### DETAILED DESCRIPTION

Implementations disclosed herein automatically select images and/or screenshots that may be more successful in marketing a game than instances in which a developer selects images and/or video. An image and/or video that is recommended may be more effective in reaching a particular audience as well. Further, a developer can spend less time deciding which images best display or advertise features of the application. In some instances, the system may recommend images, for example, that may increase the likelihood of the application being downloaded by an end user of an application store.

Typically, when an application developer attempts to publish a game or upload the game to an application store, the developer may submit one or more screenshots. In some instances, the developer may upload thousands of images. However, the application store may allow the developer to show a limited number of screenshots (e.g., ten images) and/or videos (including limits on the length and/or size of the video). In some configurations, the developer's application may be available on client devices with diverse hardware (e.g., screen size, processor, and memory). The developer may desire to utilize different screenshots for different form factors of client devices. According to an implementation, a system is provided that can automatically determine which images may increase the likelihood of the application being successful (e.g., downloaded and/or result in end user purchases). The system may utilize a classifier trained on images obtained from other successful games on the application store that are from the same category as the developer's application.

A library of screenshots may exist on the application store's database as well as other data regarding the features of the application, demographics of the users interfacing with the application store, and user activity on the application store. The images from other successful applications may be obtained from both the application store and other external sources (e.g., the developer's website). Various features regarding the images may be extracted and/or determined such as image resolution, an image simplicity, a hue, a background color, a color combination, finish type (e.g., matte or glossy), a tonal heat, etc. The classifier may be trained based on the features extracted from the existing successful applications on the application store. The application may be deemed successful based on the size of its user base, its profitability, its rating, etc. As an example, if the application is a photography application, then the images provided may show different tonal heat and it may show features regarding image editing that show how the same image can have a black and white version, a saturated colors version, etc. In contrast, a travel application may be more concerned with variety. The images associated with a travel application may not have much similarity from one image to the next; however, properties intrinsic to the images may be consistent such as the presence of vibrant colors or land formations such as a mountain, desert, ocean, etc. A racing game may show more intense graphics such as a car zooming past in a video. Features such as aperture, focus, frame rate, exposure amount, etc. may be extracted as features of the image and/or video.

Many of the features mentioned above relate to image content (e.g., color gradient, color palette). An image may be quantified in terms of quality as well. For example, image quality may be represented by how much of the space of the image is whitespace. Some applications may be more desirable if they are minimalistic. Such applications may have more whitespace. Whitespace can be determined by pixel density and/or pixel changes or shifts. A lot of whitespace can indicate that an image is of lower quality. Image quality may be reflected by resolution. A 640×480 pixel image represented 0.3 megapixels and is of low quality compared to a high definition, 13 MP image. Other examples of image quality may be when pictures have too many subjects (e.g., facial recognition detects numerous people) and/or the distance the subject is from the camera. Certain images may be deemed to be of low quality, for example, because the image is blurry or unclear. Each of the image quality and/or content features can be captured and/or represented by a feature vector or numerically.

A classifier may be trained for specific categories of applications on the application store. In addition, a classifier may be trained for specific device form factors (e.g., screen size). For example, an image may be determined by a classifier to be of a high quality for client devices with four-inch screens; but, it may be less impressive on a ten-inch tablet.

A classifier may account for demographics of a particular user base. For example, the demographic makeup of users who enjoy first person shooters may differ from that of users who utilize word processing applications. A demographic may refer to, for example, an age, a gender, and a location.

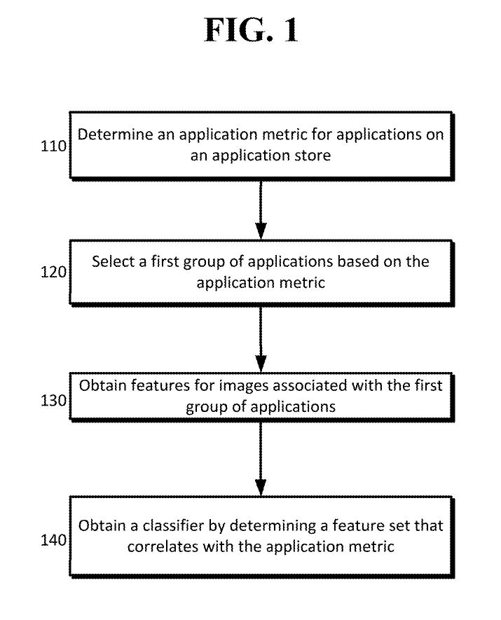

FIG. 1 is an example process for training a classifier that can determine which one or more images (or video) to select to increase the likelihood that the application will be downloaded by end users. In an implementation, one or more features extracted from the one or more images may be correlated with an application metric to generate the classifier. At 110, a server of an application store may determine an application metric for one or more applications hosted by the store. An application store may refer to a collection of servers or server farms that deliver a variety of content to end users including, but not limited to, an application, a movie, a song, and an electronic book. The application store may be accessible by a mobile device such as a smartphone or tablet as well as conventional computer systems such as a laptop or desktop computer. A client device may interface with the application store server by launching an application on a client device. For example, the client device may utilize a web browser or a stand-along application to interface with the application store. With a user's permission, the application store may receive signals from the client device that indicate a user's identity, a user's browsing history, etc. Similarly, a user's activity or use of services provided by the application store may be stored in a database connected to the application store. For example, a user's purchase history, application download or installation history, comment history, ratings history, browsing history (e.g., applications a user has viewed), other prior actions, or the like may be stored in a database and associated with the particular user. The application store may receive signals from external sources such as ratings, reviews, description, images, videos, etc. The application store may generate a recommendation for a user based on any of the aforementioned features and/or sources. For example, a user who frequently views and downloads a particular category of video game applications may receive a recommendation for a game that the user has not installed and that is rated highly by the user's peers (e.g., demographically similar users or friends of the user).

Developers may interface with the application store with a client device similar to end users. Developers may upload content such as description, title, application installation packages, images, videos, etc. to the application store. The developer may indicate which version of an application is to be provided to particular devices. For example, the developer may indicate one version of the application is intended for tablets while another version is suitable for smartphones.

An application metric may refer to a composite score based on a conversion statistic, a download statistic, a rating, a retention statistic, and a popularity statistic. A conversion statistic may refer to the number of instances in which a user makes a purchase when presented with a purchase opportunity. For example, a video game may offer an in-application purchase of an in-game item. Approximately 15% of users who view details regarding an in-game item may complete the purchase of the in-game item. Thus, the conversion rate for that particular item may be 15%. The conversion statistic may refer to an aggregated conversion rate for all in-application purchases. For example, a first item may have a conversion rate of 15% and a second item may have a conversion rate of 7%. The conversion statistic for the application, therefore, may be (7%+15%)/2 or 11%. The conversion statistic may refer to the number of instances in which an application is purchased as compared to the number of instances in which a user elects to either not install the application (e.g., just views the application's page) or keep a free version of the application.

A download statistic may refer to the number of instances in which an application is downloaded compared to the number of instances in which the application's page on the application store is viewed. For example, the download statistic may be 10% based on 10,000 downloads and 100,000 unique views of the application's page. The download statistic may be based on end user activity such as the amount of time a user spends on an applications page. For example, a download statistic may be computed as above and it may be weighted based on the average amount of time users view the application's page or content related thereto. An average amount of time for all users for all applications or a specific category in which the application is located may be computed to create an overall amount of time users spend on application pages. The average amount of time users spend on the application page divided by the overall average amount of time users spend on all applications (or applications in the same category) pages to generate a normalized average for the application. The download percentage may be multiplied by the normalized average to generate the weighted download statistic. The application would receive a lower score when a user spends a relatively small amount of time on the application's page.

A rating may refer to a user rating of the application. For example, a user may access the application store and provide a rating for an application that the user has downloaded. The rating system may be determined by the application store and ratings may be stored on a database associated with the application store. For example, the application store may allow users to rate an application on a scale of zero to five with five being the best. The rating may appear in a numerical form or be represented using a graphic such as stars. In some cases, a rating from an external source may be displayed to end users on the application's page on the application store.

A retention statistic may refer generally to the length of time a user keeps a downloaded application installed on one of the user's client devices. In some configurations, the retention statistic may be the amount of time from when a user installs an application and/or uninstalls the application. It may be based on the number on the amount of time a user uses the application and/or launches the application on the client device. For example, an average amount of time from when a user installs an application until the user uninstalls an application on a client device may be computed for all applications or applications belonging to the same category as an application of interest to generate the average retention for all applications. The time between install and uninstall may be computed for the application of interest for all users thereof to generate the average retention for the application of interest. The retention statistic may be computed as the average retention for the application of interest divided by the average retention for all applications (or applications of the same category). Users who have not uninstalled an application may have the time at which the computation is performed utilized as the effective uninstall time. The retention statistic, therefore, for a new application might be low initially.

A popularity statistic may refer to the number of downloads of the application. It may be normalized by the average number of downloads for all applications or applications of the same category. The popularity statistic may be based on other factors such as the number of views of the application page and/or the amount of time users spend on the application page, each of which may be normalized based on similar amounts for all applications or applications of the same category. The popularity statistic may be based on external source data. For example, a video aggregation site may host videos for the application and count the number of views and/or compute relative popularity of particular of videos. These data may be accessed by the application store or otherwise received by the application store. Similarly, social media trends and posts may be utilized as indicators of the relative popularity of an application. For example, the number of instances in which the application is mentioned (e.g., appears in text) on a social network may be computed and utilized as a metric for the popularity of the application.

The application metric may be computed based on one or more of the above metrics. For example, the normalized metrics for a first application may be 0.1, 0.3, 0.8, 0.2, and 0.4 for the conversion statistic, the download statistic, the rating, the retention statistic, and the popularity statistic, respectively. The sum of these metrics, which may represent the application metric, is 1.8 which can be further weighted and/or normalized based on the type of application (e.g., email, game, RPG, word game, utility, etc.).

Returning to FIG. 1, a first group of applications may be selected based on the application metric at 120. Applications with a relatively high application metric may be desirable for the training set because it may indicate that the application is generally successful. For example, it may have a large user base, generate revenue at a relatively high conversion rate, and be well received by the user base. The set of applications selected may be referred to as a training set for a supervised machine learning approach and may serve as the basis for obtaining a classifier. The data input into the machine learning technique may be deemed to be of a particular type such as a relatively high application metric. The training set of applications may be a fraction of the total applications for which features are available. Typically, in a machine learning approach, a portion of the training set is not used in training the classifier, and the analysis may be repeated. In some configurations, depending on the training set size, cross validation using a portion of the training set may be performed. As an example, the system may randomly select a percentage of applications with an application metric above a threshold score to be in the first group. As another example, the system may receive an indication of the applications to be considered in the first group from an individual supervising the machine learning technique.

At 130, features for one or more images associated with the first group of applications (e.g., the training set) may be obtained. A video may be considered a collection of images and individual frames from a video may be extracted and analyzed as an image. A non-exhaustive list of features includes: a visual density of an image, a frequency of scene changes in a video, a resolution, a color density, and/or a color combination. A visual density or texture analysis of an image may be performed, for example, using an edge detection technique, a histogram of gradients, etc. The system may utilize images that are uploaded to the application store server and/or that are associated with the application on other websites (e.g., the developer's web page for the application). Similarly, a video may be uploaded to the application store by a developer as promotional material and/or obtained from sources external to the application store such as a video aggregation website to which users can upload videos. Individual frames from a video may be analyzed similarly to an image.

A feature set that includes a portion of the features that were extracted and/or determined at 130 may be determined to be correlated with the application metric values for those applications in the first group of applications (e.g., the training set) at 140 in order to obtain a classifier. For example, a variety of machine learning techniques may be employed with any of the implementations disclosed herein such as k-nearest neighbors, linear regression, logistic regression, or support vector machine. The result of applying the supervised machine learning technique to the training set of application is that a classifier may be obtained based on the feature set. For example, a training set for first person shooter applications that are deemed to have a relatively high application metric (e.g., are considered successful) may indicate that a large number of objects in the image, a uniform color palette, and a high visual density may be positively correlated with a relatively high value for the application metric for applications belonging to the first person shooter category. Other features may be negatively correlated with the application metric for games belonging to the first person shooter category of applications. The feature set, therefore, may define a classifier that utilizes the features contained in the feature set as a basis for determining what images of first person shooter application should be utilized to increase the likelihood that the application will be downloaded by end users or otherwise be successful. A different category of applications may have a different feature set that defines relative likelihood of success (e.g., having a high application metric) for that category. Thus, the application store may have multiple classifiers for different categories of applications and generate a recommendation for images to select to market an application to end users. The recommendation may be provided to the developer who has uploaded a new or updated version of an application.

Once the classifier has been trained on the training set and possibly validated, the classifier may be applied to new applications uploaded to the application store and/or applications that were not a part of the training set. For example, a newly uploaded application may contain screenshots and/or a video. The classifier may be applied to this source material to recommend which of the images and/or video the developer should select to increase the likelihood that the application will be downloaded and/or commercially successful. For example, a developer may upload one hundred images, five videos, an installation package for the developer's game, and metadata associated therewith (e.g., title, description, category, etc.). The classifier for the indicated category (e.g., word games) may be applied to the uploaded images and videos. The classifier may return a ranked list of the images and/or videos to the developer. The ranked list may be selected from among the images provided by the developer. In this example, the system may present the developer with a ranked list of twenty applications and two videos. The images may be presented the developer. The developer may select one or more of the images from the recommendation or the developer may forgo the recommended list and proceed with other images that the classifier did not indicate would have a high likelihood of success or effectively market the application. By selecting images, recommended or otherwise, the developer may provide permission for the selected images and/or video to be shown with the application on the application store.

As an example, a classifier for texting applications may have a feature set of three features that are associated with images in successful texting applications. The three features may have scores generated for each of them. For example, the number of edges may be one feature and an edge detection performed on an image may identify 50 edges compared to the average of 75 in other texting applications on the application store. An edge detection score may be computed by 50/75 resulting in a score of 0.67. Other features for an image and/or video may be computed in a similar method or other known method. The scores for the features in the feature set may be weighted to adjust the amount of influence that any one feature has in the computation of the likelihood of success or marketability. The sum of the scores generated for each of the features identified by the classifier as being correlated with the likelihood of success may be computed for each image and/or video. The resulting list may be ranked according to the summed score values.

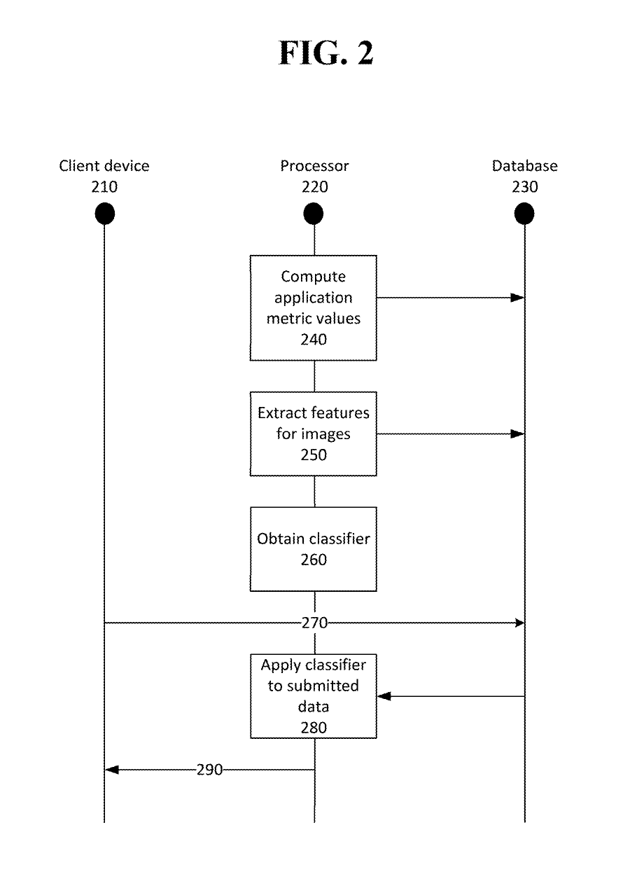

In an implementation, an example of which is provided in FIG. 2, a system is disclosed that includes a database 230 and a processor 220 connected thereto. The database 230 and processor 220 may be components of an application store server architecture. The database 230 may be store an application metric as described above. The database 230 may store application installation packages, images, videos, description, etc. of applications hosted by the application store. A processor 220 may be communicatively coupled to the database and be configured to determine an application metric for each application 240 hosted by the application store as described earlier. The computed application metrics may be stored in the database 230. The processor 220 may select a first group of applications to be utilized as a training set for a classifier based on the application metric as described above. The processor 220 may obtain or extract features for images associated with the selected group of applications at 250 and the extracted features may be stored in the database 230. The processor 230 may obtain a classifier at 260 by determining a feature set that contains features correlated with the application metric as described above. A client device 210 of a developer may send images, videos and/or an application installation package to be uploaded to the application store for submission of a new or updated application at 270. The submitted data may be stored in the database 230. The processor 220 may apply the classifier at 280 to the submitted images and/or videos and generate a recommendation. The recommendation, for example, may be a ranked list of the images and/or videos. The recommendation may be sent to the client device 210 of the developer at 290.

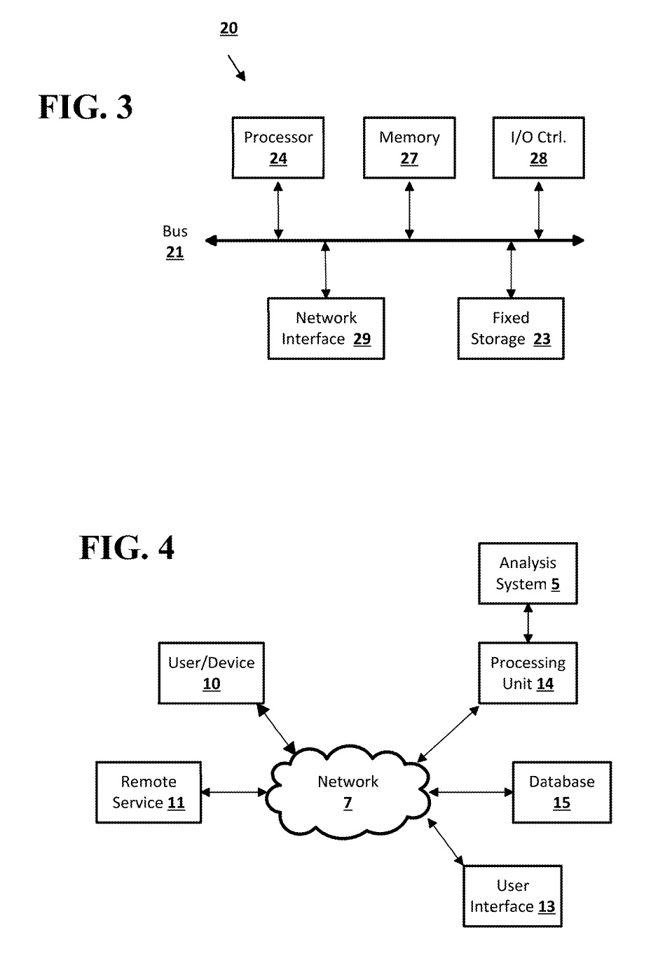

Embodiments of the presently disclosed subject matter may be implemented in and used with a variety of component and network architectures. FIG. 3 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 4.

Many other devices or components (not shown) may be connected in a similar manner, such as document scanners, digital cameras, auxiliary, supplemental, or backup systems, or the like. Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 4 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
determining, by a server of an application store, an application metric for each of a plurality of applications hosted by the application store, wherein the application metric is a composite score based on at least one of: a conversion statistic, a download statistic, a rating, a retention statistic, and a popularity statistic;
selecting a first of the plurality of applications based on the application metric;
obtaining a plurality of features for a plurality of images associated with the first of the plurality of applications on the application store; and
obtaining a classifier by determining a feature set comprising a portion of the plurality of features that correspond to the plurality of features that are correlated with the application metric.

2. The method of claim 1, further comprising selecting the first of the plurality of applications based on an application category.

3. The method of claim 1, wherein the plurality of images is obtained from a plurality of videos associated with the first of the plurality of applications.

4. The method of claim 1, further comprising:
receiving, by the server, a plurality of images for a new application from a client device;
applying the classifier to the plurality of images for the new application;
selecting a subset of the plurality of images for the new application; and
presenting the subset of the plurality of images to the client device.

5. The method of claim 4, further comprising:
determining a category for the new application; and
applying a classifier corresponding to the category to the new application.

6. The method of claim 4, further comprising receiving permission from the client device to provide the subset of the plurality of images for the new application to a plurality of users of the application store through application store.

7. The method of claim 4, further comprising ranking the subset of the plurality of images for the new application.

8. The method of claim 4, further comprising receiving a selection of the presented images by the client device.

9. The method of claim 1, wherein obtaining the classifier comprises training the classifier on the first of the plurality of applications, wherein the first of the plurality of applications have a value of the application metric above a threshold.

10. A system, comprising:
a database associated with an application store, the database configured to store an application metric, wherein the application metric is a composite score based on at least one of: a conversion statistic, a download statistic, a rating, a retention statistic, and a popularity statistic;
a processor associated with the application store and that is communicatively coupled to the database, the processor configured to:
determine an application metric for each of a plurality of applications hosted by the application store;
select a first of the plurality of applications based on the application metric;
obtain a plurality of features for a plurality of images associated with the first of the plurality of applications on the application store; and
obtain a classifier by determining a feature set comprising a portion of the plurality of features that correspond to the plurality of features that are correlated with the application metric.

11. The system of claim 10, further configured to select the first of the plurality of applications based on an application category.

12. The system of claim 10, wherein the plurality of images is obtained from a plurality of videos associated with the first of the plurality of applications.

13. The system of claim 10, the processor further configured to:
receive a plurality of images for a new application from a client device;
apply the classifier to the plurality of images for the new application;
select a subset of the plurality of images for the new application; and
present the subset of the plurality of images to the client device.

14. The system of claim 13, the processor further configured to:
determine a category for the new application; and
apply a classifier corresponding to the category to the new application.

15. The system of claim 13, the processor further configured to receive permission from the client device to provide the subset of the plurality of images for the new application to a plurality of users of the application store through application store.

16. The system of claim 13, the processor further configured to rank the subset of the plurality of images for the new application.

17. The system of claim 13, the processor further configured to receive a selection of the presented images by the client device.

18. The system of claim 10, wherein obtaining the classifier comprises training the classifier on the first of the plurality of applications, wherein the first of the plurality of applications have a value of the application metric above a threshold.
